(19) United States
(12) Patent Application Publication
(10) Pub. No.: US 2024/0192490 A1
(43) Pub. Date: Jun. 13, 2024

(54) Smart Device Mounted Augmented Reality Displays

(71) Applicant: DigiLens Inc., Sunnyvale, CA (US)

(72) Inventors: Nima Shams, Sunnyvale, CA (US); Ratson Morad, Palo Alto, CA (US)

(73) Assignee: DigiLens Inc., Sunnyvale, CA (US)

(21) Appl. No.: 18/550,875

(22) PCT Filed: Mar. 21, 2022
(86) PCT No.: PCT/US22/71244

§ 371 Date: Sep. 15, 2023

Related U.S. Application Data
(60) Provisional application No. 63/163,563, filed on Mar. 19, 2021.

(51) Int. Cl. G02B 27/01

(52) U.S. Cl. CPC G02B 27/0101; G02B 27/0149; G02B 2027/0154; G02B 2027/0161

(57) ABSTRACT

Augmented reality eyewear allows users to see both light containing image data and light from the world together to superimpose the image data onto the real world. Augmented reality eyewear may connect to a smart device. Augmented reality eyewear may include various functionality which may be duplicated on the smart device. It would be advantageous to share the functionality on both the augmented reality eyewear and the smart device. The present disclosure relates to smart device mounted augmented reality displays which may share the functionality of the smart device for the augmented reality displays.

### CROSS-REFERENCED APPLICATIONS

This application claims priority to U.S. Provisional application 63/163,563, filed on Mar. 19, 2021, the disclosure of which is included herein in its entirety.

### FIELD OF THE INVENTION

The present invention generally relates to waveguide-based displays and, more specifically, to augmented reality displays physically mounted on smart devices.

### BACKGROUND

Waveguides can be referred to as structures with the capability of confining and guiding waves (i.e., restricting the spatial region in which waves can propagate). One subclass includes optical waveguides, which are structures that can guide electromagnetic waves, typically those in the visible spectrum. Waveguide structures can be designed to control the propagation path of waves using a number of different mechanisms. For example, planar waveguides can be designed to utilize diffraction gratings to diffract and couple incident light into the waveguide structure such that the in-coupled light can proceed to travel within the planar structure via total internal reflection (“TIR”).

Fabrication of waveguides can include the use of material systems that allow for the recording of holographic optical elements within the waveguides. One class of such material includes polymer dispersed liquid crystal (“PDLC”) mixtures, which are mixtures containing photopolymerizable monomers and liquid crystals. A further subclass of such mixtures includes holographic polymer dispersed liquid crystal (“HPDLC”) mixtures. Holographic optical elements, such as volume phase gratings, can be recorded in such a liquid mixture by illuminating the material with two mutually coherent laser beams. During the recording process, the monomers polymerize, and the mixture undergoes a photopolymerization-induced phase separation, creating regions densely populated by liquid crystal micro-droplets, interspersed with regions of clear polymer. The alternating liquid crystal-rich and liquid crystal-depleted regions form the fringe planes of the grating. The resulting grating, which is commonly referred to as a switchable Bragg grating (SBG), has all the properties normally associated with volume or Bragg gratings but with much higher refractive index modulation ranges combined with the ability to electrically tune the grating over a continuous range of diffraction efficiency (the proportion of incident light diffracted into a desired direction). The latter can extend from non-diffracting (cleared) to diffracting with close to 100% efficiency.

Waveguide optics, such as those described above, can be considered for a range of display and sensor applications. In many applications, waveguides containing one or more grating layers encoding multiple optical functions can be realized using various waveguide architectures and material systems, enabling new innovations in near-eye displays for augmented reality (“AR”) and virtual reality (“VR”), compact head-up displays (“HUDs”) and helmet-mounted displays or head-mounted displays (HMDs) for road transport, aviation, and military applications, and sensors for biometric and laser radar (“LIDAR”) applications.

### SUMMARY OF THE DISCLOSURE

Many embodiments are directed to augmented reality displays physically mounted on smart devices. Various embodiments are directed to an augmented reality device with a smart device including a plurality of components; and a waveguide-based display moveably connected to the smart device. The waveguide-based display can be configured to allow a user to simultaneously view image containing light and world light. Additionally, each component of the plurality of components is positioned at a fixed distance from the waveguide-based display.

In other embodiments, the plurality of components are selected from a group consisting of:
one or more cameras (e.g. 2D camera or 3D camera);
one or more speakers;
accelerometer;
inertial measurement unit (IMU);
one or more microphones;
ambient light sensor;
depth sensor;
memory;
processor; and
battery

In still other embodiments, the augmented reality device has a projector optically coupled with the waveguide-based display.

In yet other embodiments, the waveguide-based display is housed in a case configured to house and protect the smart device.

In still yet other embodiments, the waveguide-based display is housed in a case configured to house and protect the smart device.

In other embodiments, the waveguide-based display is retractable into the case.

In still other embodiments, the projector is housed within the case.

In yet other embodiments, the case further comprises a circuit board, a battery, and a connector.

In still yet other embodiments, the connector is in electrical communication with the circuit board and the smart device.

In other embodiments, the battery is used as an auxiliary battery for the smart device.

In still other embodiments, the battery is further used to power the projector.

In yet other embodiments, the waveguide-based display comprises a positioner which fixes the distance of a user's eye from the waveguide-based display when the user is utilizing the waveguide-based display.

In still yet other embodiments, the waveguide-based display is retractable by a sliding motion.

In other embodiments, the sliding motion positions the waveguide-based display on a side of the case.

In still other embodiments, the sliding motion positions the waveguide-based display on a top portion of the case.

In yet other embodiments, the waveguide-based display is retractable by a rotational motion.

In still yet other embodiments, the rotational motion positions the waveguide-based display to a side of the case.

In other embodiments, the rotational motion positions the waveguide-based display to a top side of the case.

In still other embodiments, the projector can rotate with respect to the smart device.

Additional embodiments and features are set forth in part in the description that follows, and in part will become apparent to those skilled in the art upon examination of the specification or may be learned by the practice of the disclosure. A further understanding of the nature and advantages of the present disclosure may be realized by reference to the remaining portions of the specification and the drawings, which forms a part of this disclosure.

### BRIEF DESCRIPTION OF THE DRAWINGS

The description will be more fully understood with reference to the following figures, which are presented as exemplary embodiments of the invention and should not be construed as a complete recitation of the scope of the invention.

FIGS. 1A and 1B conceptually illustrate optical engines in accordance with embodiments.

FIGS. 2A through 2F conceptually illustrate an AR device attached to smart device in accordance with embodiments.

FIGS. 3A and 3B conceptually illustrate exploded views of an AR device connected to a smart device in accordance with embodiments.

FIGS. 4A through 4C conceptually illustrate various views of an AR device and associated internal components connected to a smart device in accordance with embodiments.

FIGS. 5A and 5B conceptually illustrate an AR device connected to smart device in accordance with embodiments.

FIGS. 6A through 6F conceptually illustrate an AR device in an extended position on the side of a smart device in accordance with embodiments.

FIGS. 7A through 7F conceptually illustrate an AR device in an extended position above the smart device in accordance with the embodiments.

### DETAILED DESCRIPTION

Waveguide based displays may be configured to enable augmented reality (“AR”) or virtual reality (“VR”). Waveguide based displays for performing AR may allow a user to see both light containing image data and light from the world together to superimpose the image data onto the real world. Typically waveguide based displays for performing AR are incorporated into AR eyewear which the user may wear. The AR eyewear may include various features which aid in producing the AR experience such as:
One or more cameras (e.g. 2D camera or 3D camera);
One or more speakers;
Accelerometer;
Inertial measurement unit (IMU);
One or more microphones;
Ambient light sensor;
Depth sensor (e.g. time of flight sensor);
Memory;
Processor; and/or
Battery

AR eyewear often connects to a smart device such as a smartphone or tablet. It has been discovered that these smart devices may include much of the same functionality as listed above which is typically included in the AR experience. Thus, it would be advantageous to utilize the functionality physically positioned on the smart device for the AR eyewear. Unfortunately, when the AR eyewear is physically separated from the smart device, much of the functionality may not be useful. For example, the accelerometer readings of the smart device would not be accurate for the AR eyewear due to the physical separation. Further, the cameras would capture a different perspective than is typical for AR eyewear due to the physical separation.

Disclosed herein is an AR eyewear directly mounted on a smart device. The AR eyewear may be an AR monocle that may extend from the top of the smart device. In one example, a user may utilize the AR monocle by holding the smart device such that the AR monocle is directly positioned in front of one of the user's eyes. Advantageously, the AR eyewear directly mounted on the smart device may utilize much of the functionality already in existence on the smart device and thus this functionality would not be duplicated for the AR eyewear. The AR eyewear may be positioned in a certain position such that the distance from the AR eyewear and the components of the smart device that include the functionality may be fixed. The fixed distances allow the functionality of the smart device to be used for both the smart device and the AR eyewear. The AR eyewear may be retractable to conceal the AR eyewear when not in use. There may be a compartment in the back of the smart device which conceals the AR eyewear when not in use.

The AR eyewear may be merely the bare components of a waveguide and a projector which injects light containing image data into the waveguide. Typically, AR eyewear physically separated from the smart device include memory and a processor for generating the image data. However, by directly mounting AR eyewear on the smart device, the AR eyewear may share processing power and storage with the smart device. Further, the AR eyewear may be powered by the smart device and thus may not include a separate battery.

In some embodiments, the AR eyewear may be part of a separate case which directly mounts to the smart device. The case may be connected either wirelessly or through a port in the smart device. For example, the case may connect through the USB-C or lightning port located on the smart device. The case may include an auxiliary battery for storage of additional power for the smart device. The case may be mounted on the back of the smart device. The case may be mounted in a particular location such that the AR eyewear may be located in a fixed location from the components of the smart device.

In various embodiments, the AR eyewear may utilize the ambient light sensor of the smart device. The ambient light sensor is typically mounted on the top of the smart device and turns off the touch screen of the smart device when the user is talking on the phone. Similarly, the ambient light sensor may sense when the user is utilizing the AR eyewear and turn off the touch screen. The AR eyewear may allow the user privacy during use. Typically, while a user is using their smart device, the smart device is visible to onlookers. Thus, sensitive information may be viewed on the smart device during use. However, the AR eyewear may not have this issue. The AR eyewear may only direct the light containing image data into the user's eye when the user's eye is present in front of the AR eyewear. Thus, it becomes difficult for an onlooker to view the image containing light going into the user's eye.

The AR eyewear designed as an AR monocle may be viewed from either of the user's eyes which may be superior to AR monocles designed as separate wearable AR monocles. Wearable AR monocles are typically designed to be worn on one side of the face and thus it may be difficult to switch the viewing eye which may be unergonomic. Further, separate wearable AR monocles may be disorienting for users because image containing light is only projected into one of the user's eyes while the user is able to see light from the world from both eyes. A smart device mounted AR monocle may solve this issue because the user is better guided to close the off eye while using the AR monocle.

Some embodiments of the AR monocles may include a positioner with the AR eyewear. When the positioner rests on the user's face, the positioner may guide the AR eyewear to the proper distance from the user's face which may allow for the optical eye relief distance from the AR eyewear. The positioner may be adjustable such that there are different sizes for different users.

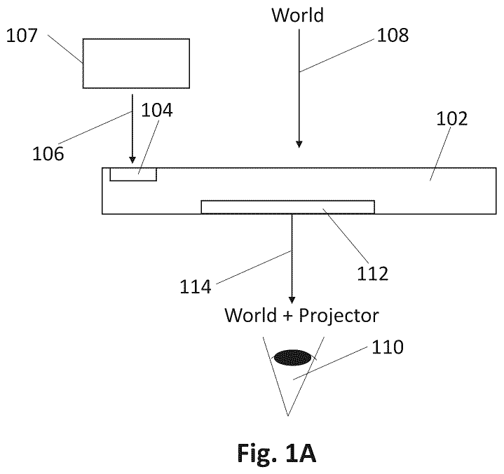

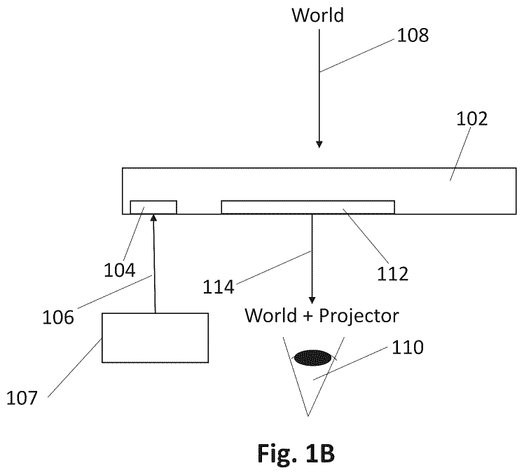

AR eyewear may include a waveguide and an optical engine. The optical engine may be used to inject image containing light into the waveguide. The waveguide may be transparent to world light and the image containing light may be outcoupled from the waveguide to the user. In some embodiments, the waveguide display is designed to have the optical engine introduce light to the front side of the waveguide (e.g. the side opposite the user's eyes). FIG. 1A is a diagram of a configuration where the optical engine includes a projector which introduces light to the front side of the waveguide in accordance with embodiments of the invention. In some AR or VR devices, the projector is configured to introduce light from the rear side of the waveguide or the same side as the user's eyes. However, it has been discovered that introducing light from the rear side of the waveguide may cause difficult alignment of the projector and the waveguides. Without limitation to any particular theory, introducing light from the rear side may cause portions of the waveguide (e.g. the incoupling optical elements and/or outcoupling optical elements) to act as mirrors which may cause difficult alignment of the projector light with the light outcoupled to the user's eye. Thus, it may be beneficial to inject light from the rear for precise alignment of the projector and the waveguide lens. However, precise alignment may be difficult to implement in a modular waveguide display where the waveguide lens and the optical engine are frequently removed and swapped.

Conversely, implementing the projector on the front side of the waveguide or on the side opposite the user's eyes allows for easier alignment of the projector and the waveguide. Without limitation to any particular theory, introducing light from the front side may cause the waveguide to act as a periscope which allows a less precisely aligned projector and waveguide to function properly. Thus, implementing the projector on the front side of the waveguide allows for easy alignment of the waveguide lens and the optical engine which is beneficial for situation where the waveguide lens and the optical engine frequently removed and swapped.

FIG. 1A illustrates an embodiment of a waveguide 102 including an incoupling optical element 104 which incouples projector light 106 from a projector 107. The projector light 106 comes from a direction on the same side of the waveguide 102 as the world light 108 and on an opposite side of the waveguide 102 as the user's eye 110. The waveguide 102 can include an outcoupling optical element 112 which outcouples light 114 including the projector light into the user's eye 110. The waveguide can further be transparent to the world light 108 and thus the user receives world and projector light 114 simultaneously. This can be advantageous in allowing the user to utilize the waveguide while simultaneously taking advantage of outside objects.

FIG. 1B is a diagram of a configuration similar to that of FIG. 1A. However, such embodiment of the optical waveguide includes a projector 107 which introduces light 106 to the rear side (i.e. the same side as the user's eye) of the waveguide in accordance with embodiments of the invention. An incoupling optical element 104 incouples projector light 106. The projector light 106 comes from a direction on the same side of the waveguide 102 as the user's eye 110 and on an opposite side of the waveguide 102 as world light 108. The waveguide 102 can include an outcoupling optical element 112 which outcouples light 114 including the projector light 106 into the user's eye 110. The waveguide is further transparent to the world light 108 and thus the user receives world and projector light 114 simultaneously. The waveguide display 102 can be advantageous in a variety of applications for a number of reasons. For example, some embodiments may be configured to project the outcoupled light 114 at a specific distance such as in a wearable display where the waveguide display is at a fixed distance from the user's eye. In other embodiments, the waveguide display can be configured to project the outcoupled light 114 to infinity, thus allowing the use of the display at any given distance. As can be appreciated various embodiments of the waveguide display can be integrated into an AR display device described herein.

As can be appreciated, the configuration of components within the waveguide display 102 can vary in a number of different embodiments. For example, in some embodiments the input and output couplers can be any type of grating element that can be used to direct the light through the display to the user's eye. The waveguide display may include a waveguide including the input coupler configured to incouple light form the projector 107 into total internal reflection (TIR) within the waveguide; and the output coupler configured to outcouple the TIR light out of the waveguide. In some embodiments, the waveguide may further include a fold grating configured to provide beam expansion to the incoupled light. The gratings can be evacuated periodic structures (e.g. evacuated Bragg gratings) or in some embodiments, the gratings can be evacuated periodic structures manufactured using Holographic Polymer Dispersed Liquid Crystal (HPDLC). Examples of evacuated period structures may be found in U.S. Pat. App. Pub. No. 2021/0063634, entitled “Evacuating bragg gratings and methods of manufacturing” and filed Aug. 28, 2020, which is hereby incorporated by reference in its entirety for all purposes.

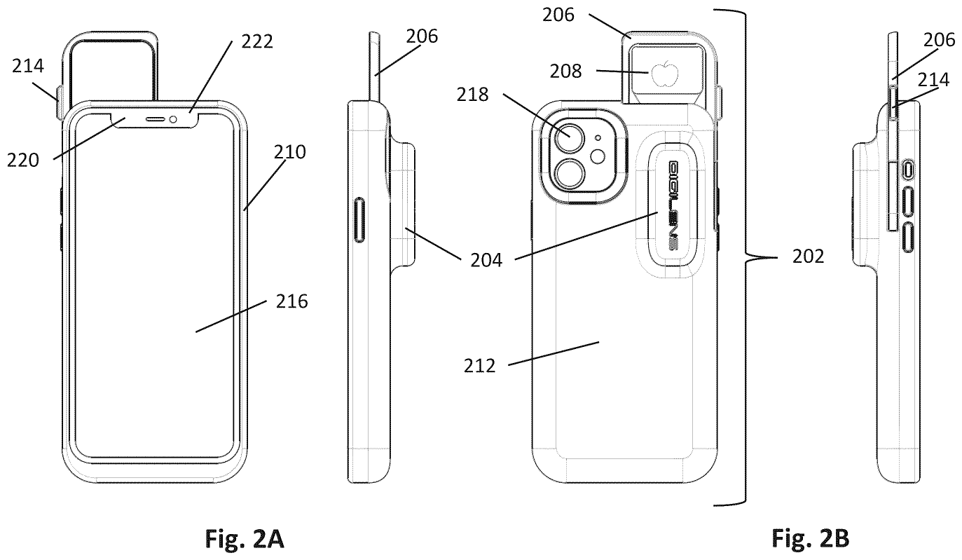

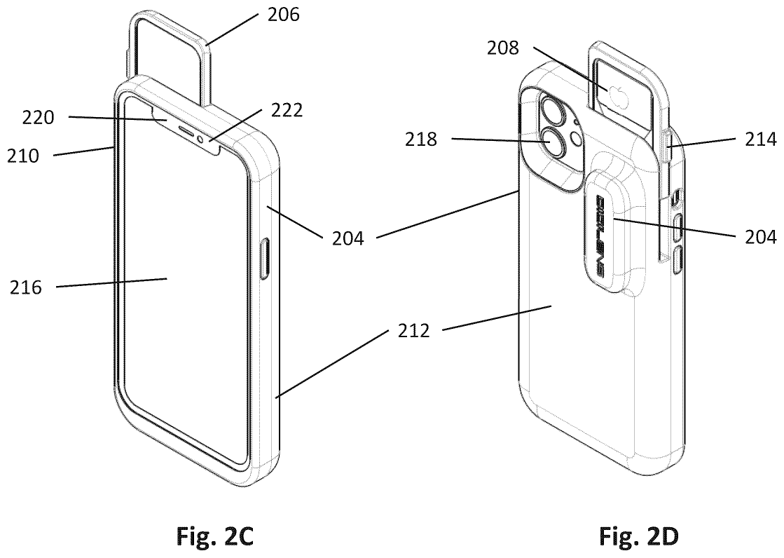

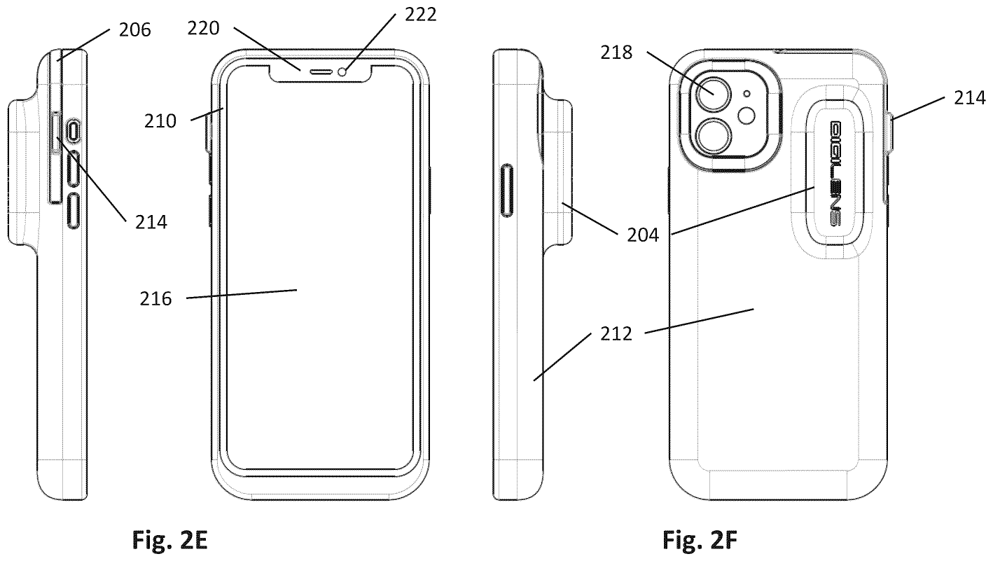

As can be appreciated, the waveguide display element illustrated in FIGS. 1A and 1B can be integrated into a number of various devices and in any number of configurations. For example, FIGS. 2A through 2F illustrate various views of an AR eyewear system 202 which can include an AR control element 204 and a display element 206. The control element 204 can have a number of different sub elements (not shown) to control the functionality of the display element 206. The display element 206 can function to display image data 208 that is generated from the control system 204. Additionally, the control system 204 can be configured to communicate with a smart device 210 such that the information from the smart device 210 is displayed by the display element. As can be appreciated, the AR eyewear system can be integrated into a case 212 for the smart device 210 or can be attached as as a separate unit entirely. Other embodiments may integrate the AR eyewear system within the smart device itself. The case 212 can be similar to that of any smart device case that provides protection for the smart device as well as provides a physical housing for the AR eyewear system 202.

As illustrated in FIGS. 2A-2F, various embodiments the display element 206 can have multiple positions such as a retracted (FIGS. 2E & 2F) or extended (FIG. 2A-2D) position. The multiple positions of the display element 206 can allow for the case 212 to function as an additional protection for the display element 206 when in a retracted position. As can be appreciated the retracted position of the display element 206 can allow the case to appear similar to other smart device cases. Additionally, some embodiments may include a sensor or switch (not shown) that can indicate the position of the display element 206 and activate or deactivate the display element 206 based on the position of the display element 206. Furthermore, some embodiments of the display element 206 can be configured with a notch or protrusion 214 that can be used to move the display element 206 between the retracted or extended position.

In accordance with various embodiments, the display element 206 can be a waveguide-based display, where the display element 206 can be partially transparent. The partial transparency of the display element 206 can allow light from the world to pass directly through the display 206, allowing the user to view image data 208 in the display 206 simultaneously with the light of the world. In some embodiments, the waveguide display system can be integrated with the smart device itself rather than a separate device attached thereto.

As illustrated in FIGS. 2A through 2D, embodiments of the AR waveguide-based display may be positioned above a display screen 216 of the smart device 210. In numerous embodiments, a user may utilize the waveguide-based display 206 at some times and at other times utilize the screen of the smart device 216. Thus, each element can act independently. In other embodiments, various applications such as games may interact with and require the use of both the waveguide-based display 206 and the screen of the smart device 216 in which the user may be required to use the waveguide-based display 206 to perform some tasks and use the screen of the smart device 216 to perform other tasks. As can be appreciated, the AR eyewear system can be used for any number of applications, including but not limited to navigation, such as GPS, translation of words or other information that may be in the view of the AR display element 206 or face filters. The AR functionality can be seamlessly integrated within any number of smart device applications and can add an improved function with the surrounding environment for the user.

In addition to the concept of translating real world information from the AR device to the screen 216 of the smart device, it can be appreciated that numerous embodiments can allow for the AR display element 206 to translate or project information into the real world. For example, some applications of the system can be a pass-through version of the application that could utilize the camera and the screen of the smart device in one mode, with the display element 206 retracted. However, when extended, the display element 206 could translate information from the screen of the smart device 216 to the outside world creating a projected image for the user. Essentially, the user would be able to view and interact with the smart device without physically interacting with the screen 216 of the device. As can be appreciated, there are a number of different configurations in which the AR eyewear system can interact with a smart device. In some embodiments, the AR eyewear system can magnetically connect with a smart device and be configured to transmit data wirelessly.

As can be appreciated by the configuration of AR eyewear system and the waveguide display 206 within the case 212 can be advantageous for a number of reasons. For example, the case 212 and configuration of the waveguide display 206 within the case maintains the position of the waveguide display 206 at a fixed location with respect to other components of the smart device 210, such as the camera or camera array on the back 218. Additionally, the waveguide display 206 can be in a fixed position with respect to other components such as a front camera 220 and an ambient light sensor 222. Furthermore, the position of the waveguide display remains fixed with respect to other components of the smart device, including, but not limited to, GPS antennas, accelerometers, IMU, microphone(s), and/or any other sensor incorporated into the smart device 210. This can be advantageous since the AR eyewear system can utilize the functions of the respective sensors and/or cameras to generate image data for the display element 206. This can simplify the configuration of the AR eyewear system since it would not require its own separate cameras and/or sensors. Although, the smart device case 212 and AR eyewear system 202 illustrated herein present a particular configuration, it should be well understood that such configuration can be changed and adapted to any particular smart device such as an iPhone, Android based device, or any other smart device with similar capabilities.

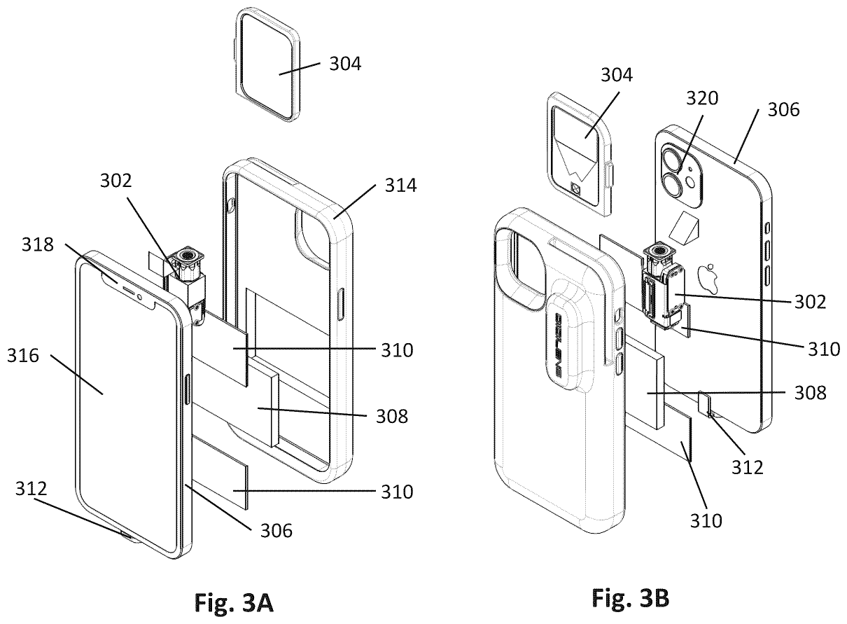

Turning now to FIGS. 3A and 3B various exploded views of an AR eyewear system and the various components are illustrated. In many embodiments the AR eyewear system can have a projector 302 to project light image data into a waveguide-based display element 304. The AR eyewear system can have additional components that can facilitate the transfer of information and/or power between the projector 302, the display element 304 as well as the smart device 306. For example, many embodiments of the AR eyewear system may have a battery 308 connected to the projector 302 and/or the display element 304. The battery can be used to power the various components of the AR eyewear system as well as serve as auxiliary power supply for the smart device.

Numerous embodiments of the AR eyewear system may have one or more circuit boards 310 positioned throughout the system. Each of the circuit boards can have a memory and a processor used to control the projector 302 as well as the display element 304. For example, the memory can be used save instructions that are transmitted to the processor to control the projector 302 in projecting light to the display element 304. In various embodiments, the circuit boards 310 can have an onboard CPU chip that can allow the AR eyewear system to have applications and software specific to the functionality of the AR system. This would allow the AR eyewear system to operate independently from the smart device 306 and thus reduce the potential tax on the onboard systems of the smart device 306. Additionally, the circuit boards 310 can also serve to control the flow of information and/or power to and from the smart device 306 through a connector 312 and/or cable. The connector 312 can be configured to engage with a charging port or data port of the smart device and can therefore transfer data between the smart device 306 and the AR eyewear system. In some embodiments, the connector 312 can also serve as a power transfer element to help charge the smart device 306. The connector 312 can be any suitable connection such as a USB, USB-C, Micro USB, lightning port, or any other suitable connection.

As can be appreciated, the various components of the AR eyewear system can be housed in an external housing 314 and can be hidden within the housing 314. In some embodiments, the housing 314 can act as a case for the smart device. Other embodiments may configure the components to be self-contained in a stand-alone unit that can connect to the smart device 306 by any number of means. For example, the stand-alone configuration may communicate wirelessly through any suitable wireless technology such as Bluetooth, near field communications, or even cellular networks.

In many embodiments, the AR eyewear system can be positioned in close proximity to the smart device and other components of the smart device such that it can capitalize on the advanced systems already integrated into the smart device 306. For example, many embodiments may utilize the various components (316, 318, and/or 320) of the smart device 306 for generating data for the AR eyewear system. Various embodiments may also share features of the smart device 306 such as not limited to:
One or more cameras (e.g. 2D camera or 3D camera);
One or more speakers;
Accelerometer;
Inertial measurement unit (IMU);
One or more microphones;
Ambient light sensor;
Depth sensor (e.g. time of flight sensor);
Memory;
Processor; and/or
Battery

Advantageously, positioning the AR eyewear system where the components of the smart device 306 are at a fixed distance from the waveguide-based display 304 allows for the AR eyewear to utilize the components of the smart device 306 rather than duplicating these components. As illustrated, these components may be located on the front of the device or the back of the smart device. The components may include an ambient light sensor 318 located on the front of the device adjacent to the waveguide-based display 304. The ambient light sensor 318 may be used to disable the screen 316 of the smart device while the user's eye is positioned in viewing position of the waveguide-based display 304. Similarly, the waveguide-based display, in various embodiments, can be located near the camera or camera sensors 320 of the smart device on the back of the smart device 306. Similar to utilizing the ambient light sensor 318, the AR eyewear system can utilize the camera or camera sensors 320 to produce images for the waveguide-based display 304. This simplifies the control elements of the AR eyewear system since it does not necessarily require the use of self-contained cameras and/or camera sensors.

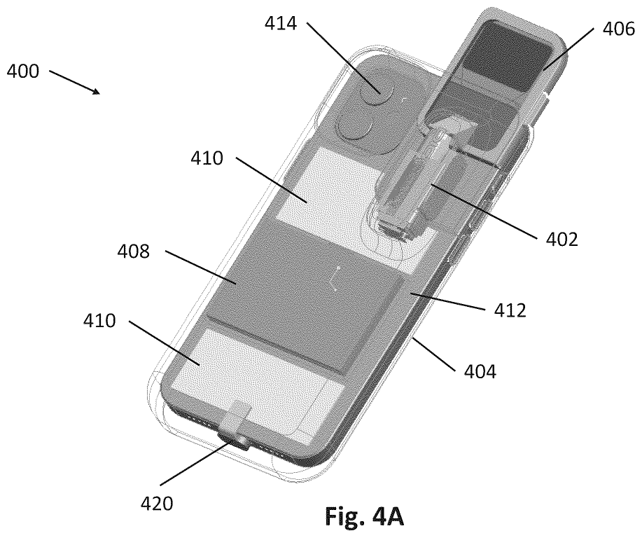

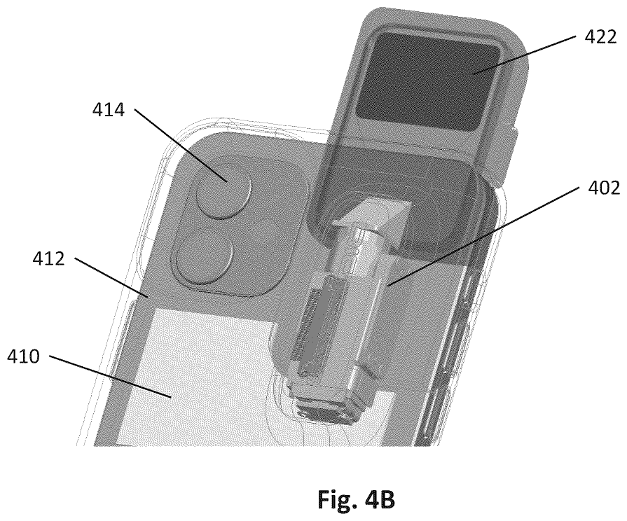

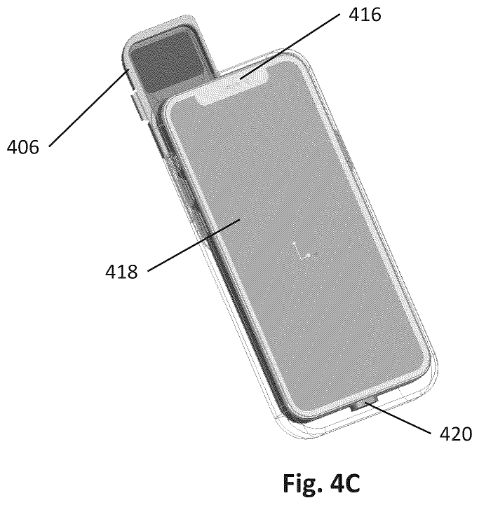

Turning now to FIGS. 4A through 4C, an AR eyewear system integrated into a smart device case is illustrated. Much like the exploded view illustrated in FIGS. 3A and 3B, FIGS. 4A through 4C illustrate the various components of the system as installed in a case structure. For example, FIG. 4A illustrates a rear view of an AR eyewear system 400 with a projector 402 enclosed within a case 404. The AR eyewear system also has an extended display element 406. As illustrated, the AR eyewear system can be connected to a battery element 408 and one or more circuit boards 410 that can serve as control systems with memory elements and processors to help control the function of the projector 402 and/or the display 406. Additionally, the circuit boards 410 can have communication elements that can allow for the projector 402 to communicate with a smart device 412 located in the case 404. The communication elements can transmit signals generated by one or more cameras or other sensors 414 and 416 on the smart device 412. The communication element, can be any suitable element and may be wired or wireless. For example, the system can also have a connection cable 420 that is routed in the case 404 and connects the smart device 412 with one or more of the circuit boards 410 such that it can transmit information and/or power between the projector and the smart device 412. In other embodiments, the communication system can be wireless such as Bluetooth.

As can be seen in greater detail in FIG. 4B, the projector 402 can be positioned near a bottom or lower portion of display element 406 when the display element is extended. Once activated, the projector 402 can project an image 422 into the display element 406. The projector, in accordance with many embodiments can utilize a number of different light sources to project the image into the display element 406. In addition to the images generated by the projector 402, the projector can also be configured to project images into the display 406, where the images were originally generated from one or more sensors from the smart device 412. As with other embodiments described above, the circuit boards 410 can control communication between the projector 402 and display 406 as well as the main screen 418 on the front of the smart device. In other words, in some embodiments, the active display element 406 can trigger the deactivation of the main screen 418. Likewise, the retraction of the display element 406 can allow for the activation of the main screen 418 of the smart device. This can be fully appreciated by FIG. 4C, illustrating a front view of the AR eyewear system with the smart device 412 in the case 404.

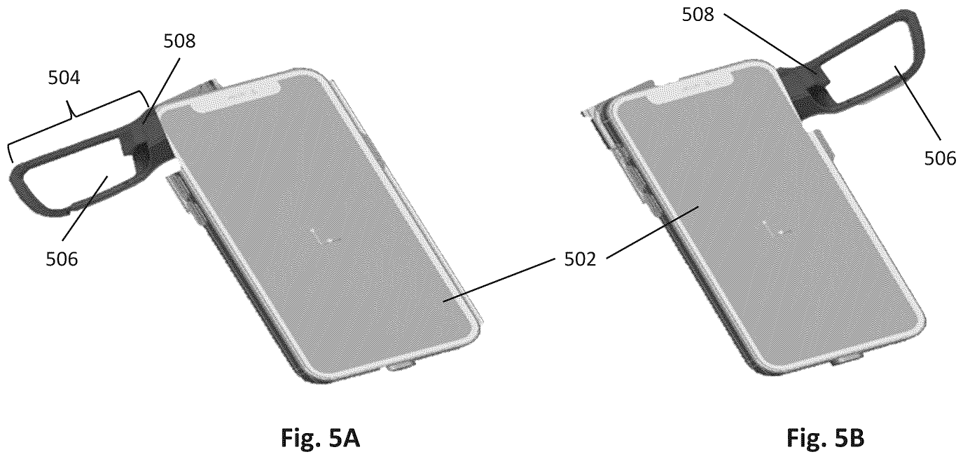

The configuration and placement the AR eyewear system can vary in any number of embodiments. For example, FIGS. 5A through 7F illustrate embodiments of an AR eyewear system that can be extended into a number of different positions by way of a number of different movements. For example, FIGS. 5A and 5B illustrate a smart device 502 with a retractable AR eyewear system 504 that is connected to the smart device 502 and can be extended out to the side of the smart device 502. The AR eyewear system, like many embodiments, can have a display element 506 the extends outward to the side of the smart device 502. The display element 506 is connected to a projector 508 that moves in conjunction with the movement of the display element 506. As can be appreciated, the movement of the AR eyewear system can be rotational such that it pivots about a singular point to move the display element 506 in a position that can be viewed by the user. In a number of embodiments, the AR eyewear system can be positioned on either side of the smart device 502 as illustrated in FIGS. 5A and 5B. In some embodiments, the AR eyewear system 504 can be rotated or moved to either side at any given time and depending on the desired location of the user.

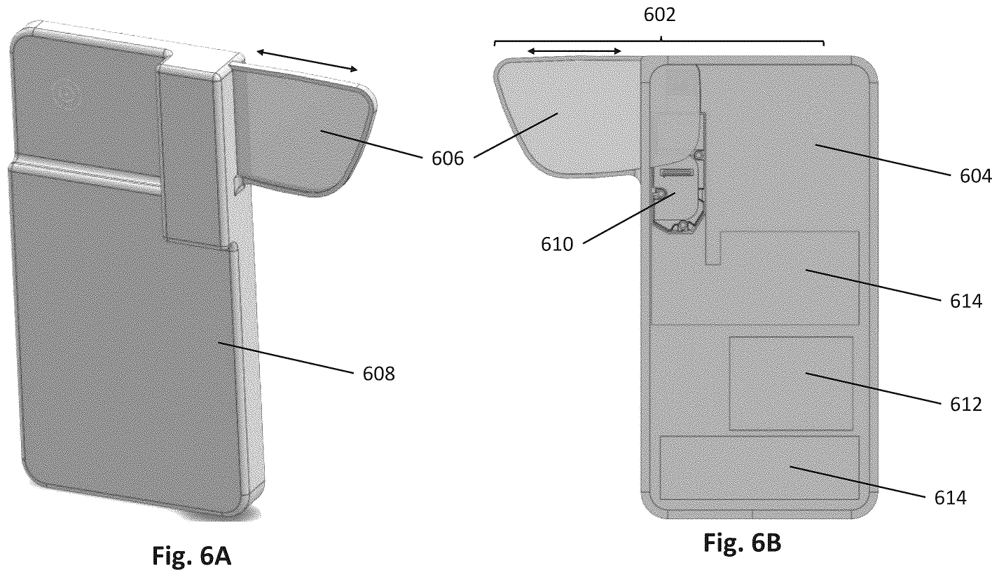

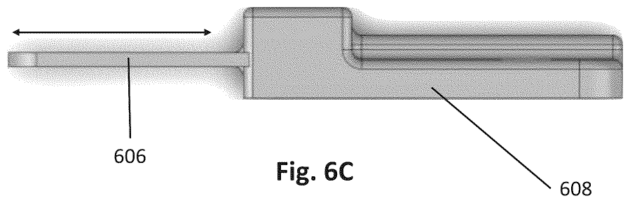

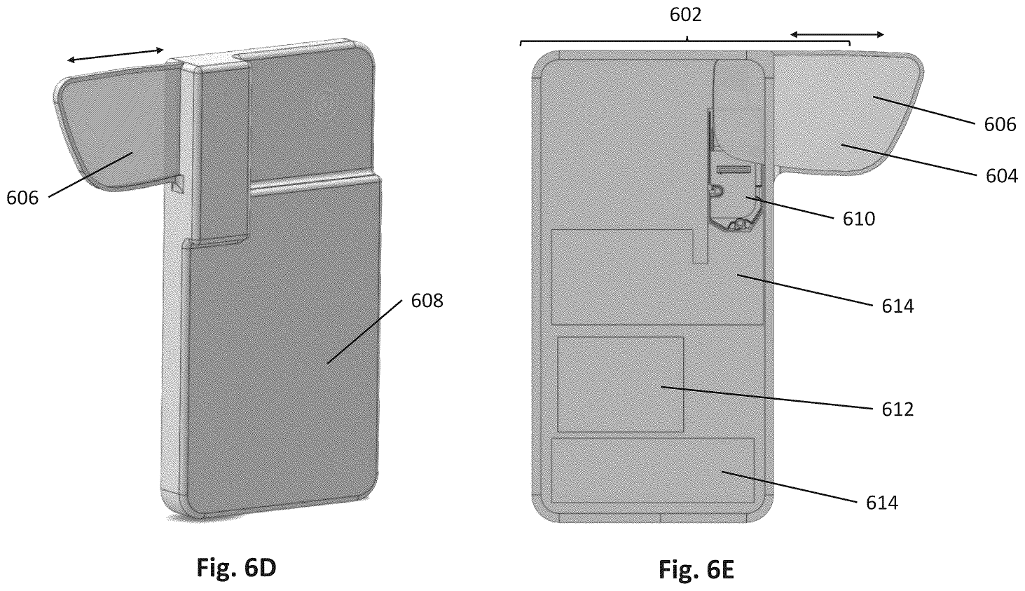

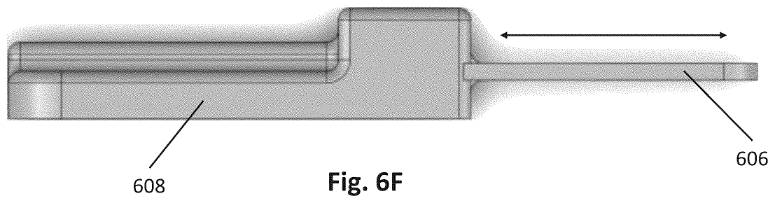

FIGS. 6A through 6F illustrate various views of an AR eyewear system 602 installed on a smart device 604 in accordance numerous embodiments. The AR eyewear system 602 can have a waveguide-based display 606 that can be retracted and extended into a case 608 for the smart device. The waveguide-based display 606 can be configured to slide in and out of the case such that it extends out to one side of the case 608 as represented by the directional line above the display 606. FIGS. 6A through 6C illustrate the waveguide-based display 606 extending out to one side while FIGS. 6D through 6F illustrate the waveguide-based display 606 extending out to the opposite side. In many embodiments, the waveguide-based display can be set up to move independently from a projector 610 that is also housed in the case 608. The projector can be in a fixed position and be activated when the waveguide-based display 606 is extended out of the case 608. As with other embodiments, the system can have a number of other components to aid in the function of the system such as batteries 612 and one or more circuit board controllers 614.

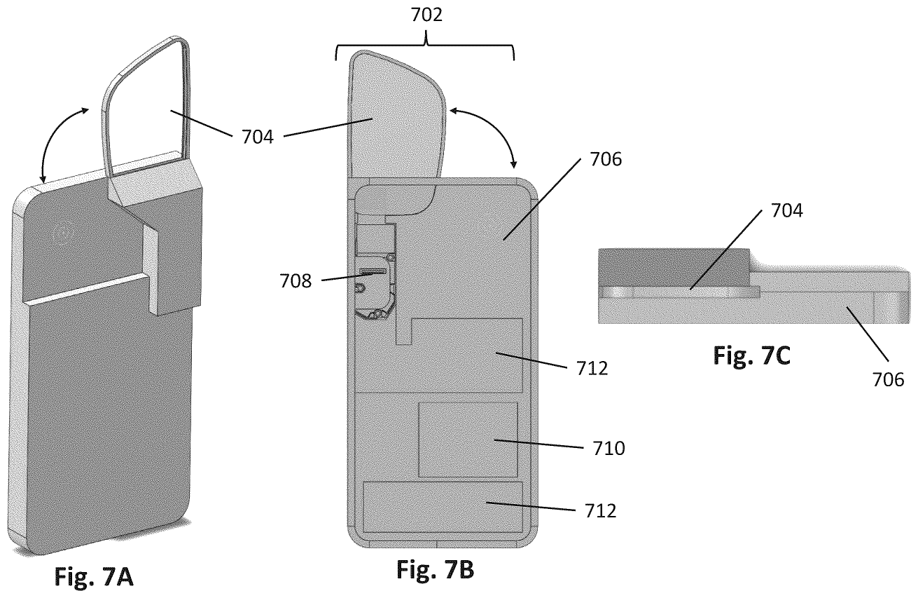

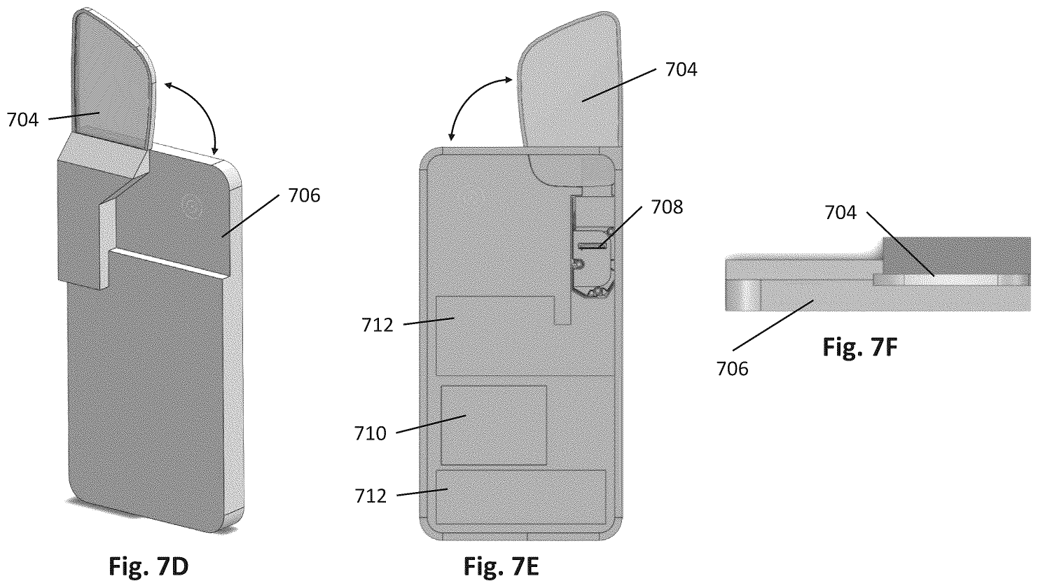

Other embodiments can include an AR eyewear system that is rotationally connected to a smart device. For example, FIGS. 7A through 7F illustrate embodiments of an AR eyewear system 702 with a waveguide-based display 704 moveably connected to a smart device 706. In numerous embodiments, the waveguide-based display 704 is optically coupled to a projector 708 such that the projector 708 can project image data to the waveguide-based display 704. In accordance with many embodiments, the projector 708 and the waveguide-based display 704 can rotate with respect to the smart device 706, as indicated by the arrows, such that the pair can rotate between an extended position and a retracted position. In such embodiments, the rotation of the waveguide-based display and the projector 708 can position the waveguide-based display 704 above the top of the smart device 706. FIGS. 7A through 8C illustrate an embodiment where the waveguide-based display 704 and projector 708 are positioned on one side of the smart device 706, while FIGS. 8D through 7F illustrate the waveguide-based display 704 on the opposite side. As should be understood by those skilled in the art, the waveguide-based display can be rotated independently from the projector 708 in some embodiments. Furthermore, as should be well understood, many embodiments can be configured with batteries 710 as well as one or more circuit boards 712 to control the function of the waveguide-based display 704, the projector 708 and/or the smart device 706.

It can be appreciated that the potential uses for the waveguide-based display incorporated into or connected with a smart device can be expanded in any number of ways. For example, some embodiments of the waveguide-based display can be configured with additional features and components that can allow the waveguide based display to be used for eye tracking of a user. Examples of eye tracker systems including various additional components that may be included in the disclosed waveguide-based display are disclosed within U.S. Pat. No. 10,209,517 to Popovich, the disclosure of which is incorporated herein by reference in its entirety for all purposes. This can aid in the function of the AR eyewear system by activating the system or augmenting the system as needed based on the eye movement of the user.

As can be appreciated a smart device, as described in the various embodiments herein can be any number of smart devices. For example, it can be a cellular phone, a computer, tablet, or any other suitable device that can connect, share and/or interact with the user. While various embodiments illustrated herein have thus far been targeted towards a monocle design, a skilled artisan would recognize that the AR eyewear may include other form factors such as a binocular design or a heads-up display. Such binocular or heads-up display designs may fold out of the case of the AR eyewear. Further, while the waveguide-based display is illustrated to slide out of the case of the AR eyewear, a skilled artisan would recognize that the waveguide-based display may be configured to retract and/or extend in any number of different ways.

As can be appreciated, the various embodiments of an AR eyewear system can be used for a number of different applications including but not limited to:
Navigation and direction (may provide great expansion of existing applications on smart devices);
Translation of signs or words from one language to another;
AR Gaming (e.g. Pokémon Go);
AR Assets (e.g. non-fungible token (NFT) such as nbatopshots, VeVe, etc.);
AR Filters (e.g. Snapchat like face filters); and/or
AR blueprints/schematics (e.g. looking at piping in a new construction or wall) Additionally, it can be appreciated that the AR eyewear system, in accordance with many embodiments, can interact with any number of mobile applications that can be downloaded and controlled by the smart device. In some such embodiments, the AR eyewear system can be configured with its own mobile application and/or software such that it can be moved between smart devices and integrate seamlessly with other smart devices.

Having an AR eyewear system, in accordance with many embodiments described herein, presents various advantages including but not limited to:
Increased ergonomics, as the projection image of the display system can be used by either eye of the user;
When integrated into a binocular system, the AR eyewear can rest on a user's face to make the device more comfortable to hold;
The adaptability of the waveguide-based display can be adjusted to project the images at the center of the eye-box;
The movability of the system can protect the system when not in use;
A variety of mobile applications on any OS platform can be configured to work with the AR eyewear system; and/or
As a peripheral of the phone, can be easily replaced or upgraded.

### DOCTRINE OF EQUIVALENTS

While the above description contains many specific embodiments of the invention, these should not be construed as limitations on the scope of the invention, but rather as an example of one embodiment thereof. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. An augmented reality device comprising:
a smart device including a plurality of components; and
a waveguide-based display moveably connected to the smart device,
wherein the waveguide-based display is configured to allow a user to simultaneously view image containing light and world light, and
wherein each component of the plurality of components is positioned at a fixed distance from the waveguide-based display.

2. The augmented reality device of claim 1, wherein the plurality of components are selected from a group consisting of:
one or more cameras;
one or more speakers;
accelerometer;
inertial measurement unit (IMU);
one or more microphones;
ambient light sensor;
depth sensor;
memory;
processor; and
battery

3. The augmented reality device of claim 1, further comprising a projector optically coupled with the waveguide-based display.

4. The augmented reality device of claim 3, wherein the projector can rotate with respect to the smart device.

5. The augmented reality device of claim 3, wherein the waveguide-based display comprises a waveguide comprising:
an input coupler configured to incouple light from the projector into total internal reflection (TIR) light within the waveguide; and
an output coupler configured to outcouple the TIR light out of the waveguide.

6. The augmented reality device of claim 5, wherein the waveguide further comprises a fold grating configured to provide beam expansion to the incoupled light.

7. The augmented reality device of claim 1, wherein the waveguide-based display is housed in a case configured to house and protect the smart device.

8. The augmented reality device of claim 3, wherein the waveguide-based display is housed in a case configured to house and protect the smart device.

9. The augmented reality device of claim 8, wherein the waveguide-based display is retractable into the case.

10. The augmented reality device of claim 9, wherein the waveguide-based display is retractable by a sliding motion.

11. The augmented reality device of claim 10, wherein the sliding motion positions the waveguide-based display on a side of the case.

12. The augmented reality device of claim 10, wherein the sliding motion positions the waveguide-based display on a top portion of the case.

13. The augmented reality device of claim 9, wherein the waveguide-based display is retractable by a rotational motion.

14. The augmented reality device of claim 13, wherein the rotational motion positions the waveguide-based display to a side of the case.

15. The augmented reality device of claim 13, wherein the rotational motion positions the waveguide-based display to a top side of the case

16. The augmented reality device of claim 8, wherein the projector is housed within the case.

17. The augmented reality device of claim 8, wherein the case further comprises a circuit board, a battery, and a connector.

18. The augmented reality device of claim 17, wherein the connector is in electrical communication with the circuit board and the smart device.

19. The augmented reality device of claim 17, wherein the battery is used as an auxiliary battery for the smart device.

20. The augmented reality device of claim 17, wherein the battery is further used to power the projector.

21. The augmented reality device of claim 1, wherein the waveguide-based display comprises a positioner which fixes the distance of a user's eye from the waveguide-based display when the user is utilizing the waveguide-based display.
